(19) United States
(12) Patent Application Publication
(10) Pub. No.: US 2009/0300144 A1
(43) Pub. Date: Dec. 3, 2009

(54) HINT-BASED STREAMING OF AUXILIARY CONTENT ASSETS FOR AN INTERACTIVE ENVIRONMENT

(75) Inventors: James E. Marr, Burlingame, CA (US); Payton R. White, Foster City, CA (US); Stephen C. Detwiler, Oakland, CA (US); Attila Vass, Foster City, CA (US)

Correspondence Address: JOSHUA D. ISENBERG;JDI PATENT, 809 CORPORATE WAY, FREMONT, CA, 94539, US

(73) Assignee: Sony Computer Entertainment Inc., Tokyo (JP)

(21) Appl. No.: 12/132,568

(22) Filed: Jun. 3, 2008

(51) Int. Cl. G06F 3/048; G06F 15/16

(52) U.S. Cl. 709/219; 715/764

(57) ABSTRACT

Methods for obtaining and distributing auxiliary content assets for an interactive environment and a client device and server that may implement such methods are disclosed. The client device displays a scene of a portion of the simulated environment from a camera point of view (camera POV) on a video display. The client device generates a pre-hint vector based on position of the camera POV, sends the vector to a server and receives auxiliary content information from the server. The server receives the pre-hint vector, determines the future field from the pre-hint vector, identifies one or more auxiliary content targets within the potential future field of view, and sends auxiliary content information for the identified targets to the client device.

### FIELD OF THE INVENTION

This invention is related to electronic computing and more particularly to distribution of auxiliary content for an interactive environment.

### BACKGROUND OF THE INVENTION

The growth of the Internet and the popularity of interactive entertainment such as video games have led to opportunities for advertising within video games. At first, advertisements were statically placed within video games. As video game consoles with internet connectivity became available, it became possible to update advertisements appearing within video games. This led to many avenues for game console manufacturers and video game companies to generate revenue from the sale of advertising space within video games to one or more advertisers. Advertising content often varies based on the nature of the video game title. In addition, certain advertising spaces within the game may be more valuable than others. Furthermore, advertising campaigns may change over time with certain advertisements being phased out as others are phased in. It is therefore useful to have some system for determining which advertisements are to be placed in particular spaces within particular video games during particular periods of time.

Conventionally, a video game console may connect to a distribution server that determines what advertisement to place in a particular advertising space within the game based on considerations such as the game title and the time of day, month year, etc. Often the actual advertising content is stored on a separate server known as a content server. In such a case, the distribution server instructs the game console to contact a particular content server and to request one or more content file or files referred to herein as content assets that a video game console may use to generate the content for a particular advertising space. The console can then directly contact the content server and request the designated content assets. These content assets may be temporarily stored in a cache on the video game console to facilitate quick updating of the content in advertising spaces within the video game.

The growth of the Internet and the popularity of interactive entertainment such as video games have led to opportunities for advertising within video games. Video games and other forms of interactive entertainment have been increasingly popular among members of demographic groups sought after by advertisers. Consequently, advertisers are willing to pay to have advertisements for their products and/or services within interactive entertainment, such as video games.

There have been—and continue to be—numerous cases wherein actual advertisements of advertisers are deployed and displayed within a video game environment. A classic example is in a driving game, wherein advertisements are pasted onto billboards around a driving course as illustrated in U.S. Pat. Nos. 5,946,664 and 6,539,544, the disclosures of which are incorporated herein by reference. With such in-game advertising, the software publishing company that creates the video game identifies an advertiser, creates texture data based on ad copy provided by the advertiser and places this texture data representative of an advertisement in the video game environment (i.e., posting the advertisement on the billboard). U.S. Pat. No. 5,946,664 to Kan Ebisawa describes the general notion of using a network to replacing an asset within a game using a texture, e.g., billboard.

Due to the dynamic nature of the distribution of information over computer networks, advertising displayed within video games may need to be updated quite rapidly. Furthermore, there may potentially be a very large number of targets for advertisement textures within a game environment. Generally, a video game console has limited storage space available for all possible advertising textures for each possible target. Furthermore, it is the video game player who determines which parts of the video game “world” will be displayed. Since a player may only visit a limited portion of the game world, only a limited number of advertising textures need to be downloaded. Even if downloading all of the advertising textures for an entire game world were possible it may not be practical due to network bandwidth and latency limitations.

To facilitate realism in a free-form game, parts of a “world” are sometimes paged in on the fly as a user plays the game. Since parts of the “world” may include advertising it is desirable to update the advertising content as quickly as possible. Unfortunately, due to the dynamic nature of free-form video games, the game console generally doesn't know how long it will take to load advertising content from the network so that it can be pre-fetched in time to present it to the user.

It is within this context that embodiments of the invention arise.

### BRIEF DESCRIPTION OF THE DRAWINGS

The teachings of the present invention can be readily understood by considering the following detailed description in conjunction with the accompanying drawings, in which:

FIG. 1 is a schematic diagram of an auxiliary content distribution system according to an embodiment of the present invention.

FIG. 1A illustrates an example of advertising within a simulated environment on a client device.

FIG. 1B is a schematic diagram of a simulated environment containing an advertisement.

FIG. 2 is a flow diagram illustrating pre-fetching of auxiliary content assets according to an embodiment of the present invention.

FIG. 3 is a block diagram illustrating a client device according to an embodiment of the present invention.

FIG. 4 is a block diagram illustrating a distribution server according to an embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

Embodiments of the invention allow a game console can send a pre-fetch vector including information regarding a point of view position (e.g., a camera POV or player's avatar position) and movement of the POV, such as a velocity vector v to server connected to a network. The server can use the information to determine a potential future field of view. The distributor can identify ad spaces within the potential field of view and supply information for obtaining necessary ads for these spaces. Embodiments of the invention envision a simple command that the console can send to the distributor having syntax such as get spaces around(x, y, . . . ) to which the distributor could respond with information identifying ads for targets within a region surrounding the POV, servers from which to download the ads, and the like. This allows advertising content to be pre-fetched from a network so that it is available at the client device in time to present it to the user.

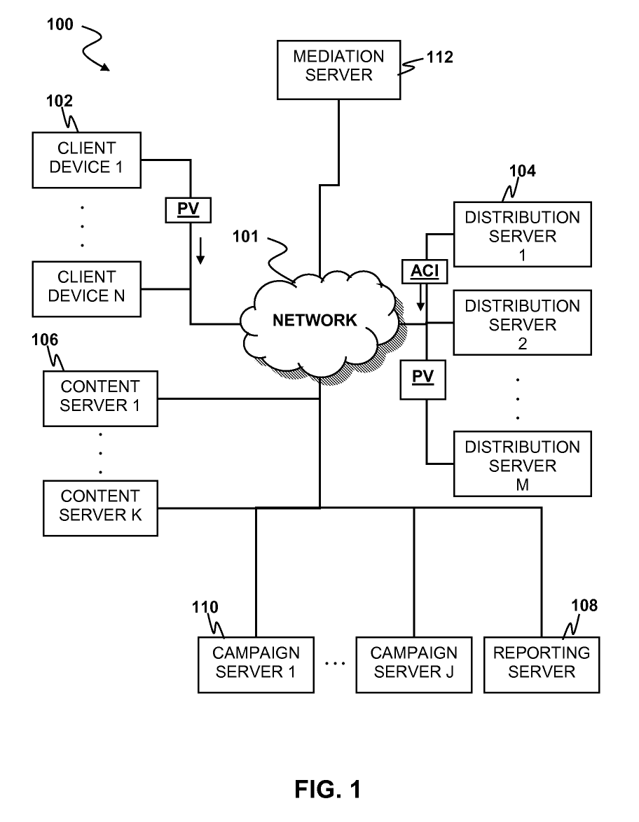

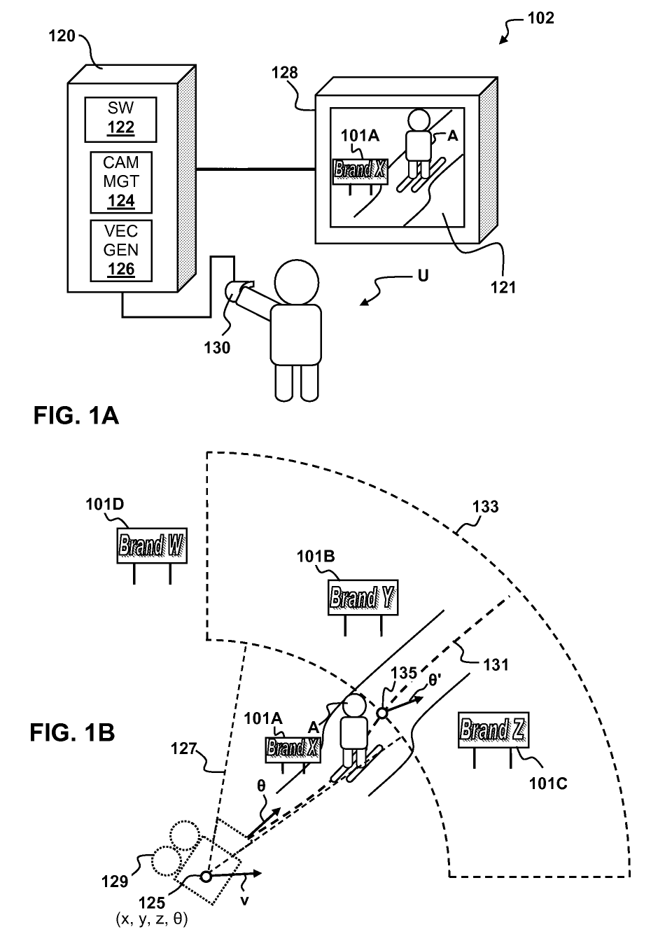

As seen in FIG. 1 a cached content consistency management system 100 may include one or more client devices 102 and one or more distribution servers 104. The client devices 102 and distribution servers 104 may be configured to communicate with each other over a network 101. By way of example, and without loss of generality, the network 101 may be a bi-directional digital communications network. The network 101 may be a local area network or wide area network such as the Internet. The network 101 may be implemented, e.g., using an infrastructure, such as that used for CATV bi-directional networks, ISDN or xDSL high speed networks to enable network connections for implementing certain embodiments of the present invention.

By way of example, and without limitation, the client devices 102 may be video game consoles. Examples of commercially game consoles include the Xbox® from Microsoft Corporation of Redmond Wash., the Wii® from Nintendo Company, Ltd of Kyoto, Japan and PlayStation® devices, such as the PlayStaion3 from Sony Computer Entertainment of Tokyo, Japan. Xbox® is a registered trademark of Microsoft Corporation of Redmond, Wash. PlayStation®is a registered trademark of Kabushiki Kaisha Sony Computer Entertainment of Tokyo, Japan. Wii® is a registered trademark of Nintendo Company, Ltd of Kyoto, Japan. Alternatively, the client devices may be any other type of network capable device. Such devices include, but are not limited to cellular telephones, personal computers, laptop computers, television set-top boxes, portable internet access devices, portable email devices, portable video game devices, personal digital assistants, digital music players, and the like. Furthermore, the client devices 102 may incorporate the functions of two or more of the devices in the examples previously listed.

As used herein the term content refers to images, video, text, sounds, etc. presented on a display in a simulated environment. Such content may include content that is an integral part of the simulated environment, e.g., background scenery, avatars, and simulated objects that are used within the simulated environment. Content may also include auxiliary content that is not integral to the simulated environment, but which may appear within it. As used herein, the term “auxiliary content” means content, e.g., in the form of text, still images, video images, animations, sounds, applets, three-dimensional content, etc, that is provided gratuitously to the client device 102. By way of example, and without limitation, within the context of an interactive environment, e.g., a video game, three-dimensional content may include information relating to images or simulations involving three dimensions. Examples of such information may range from static geometry through to a subset of a game level or a full game level with all of the expressive interactivity of the game title itself. Examples of auxiliary content include advertisements, public service announcements, software updates, interactive game content, and the like.

Content, including auxiliary content, may be generated by the client devices from content assets. As used herein, the term “content assets” refers to information in a format readable by the client device that the client device may use to generate the content. Content, including auxiliary content, and corresponding content assets may be created “on the fly”, i.e., during the course of a simulated environment session.

The auxiliary content may appear at one or more pre-defined locations or instances of time in a simulated environment generated by the client device 102. As used herein, the term “simulated environment” refers to text, still images, video images, animations, sounds, etc, that are generated by the client device 102 during operation initiated by a user of the device. By way of example, and without limitation, a simulated environment may be a landscape within a video game that is represented by text, still images, video images, animations, sounds that the client device 102 presents to the user.

The client devices 102 may retrieve the auxiliary content assets from one or more content servers 106. The distribution servers 104 may determine which particular items of auxiliary content belong in particular spaces or time instances within the simulated environments generated by the client devices 102. Each distribution server 104 may be responsible for distribution of auxiliary content to client devices 102 in different regions.

In certain implementations, e.g., where the cached content includes advertising content, the system may optionally include one or more content servers 106 and one or more reporting servers 108 one or more campaign management servers 110. In some implementations, the system may include an optional mediation server 112 to facilitate distribution of content. Each client device 102 may be configured to submit input to the mediation server 112. The mediation server 112 may act as an intermediary between the client devices 102 and the distribution servers 104. By way of example, the mediation server 112 may determine which distribution server 104 handles auxiliary content distribution for a client device in a particular region. The mediation server 112 may be configured to receive the input from a client device 102 and send contact information for a distribution server 104 to the client device 102 in response to the input. Each client device 102 may be further configured to receive the contact information from the mediation server 112 and use the contact information to contact one or more of the distribution servers 104 with a request for auxiliary content information for an auxiliary content space. The distribution servers 104 may be configured to service requests for auxiliary content information from the one or more client devices 102. The mediation server 112 may have a pre-existing trust relationship with each client device 102. By way of example, the trust relationship may be established using Public key cryptography, also known as asymmetric cryptography. The pre-existing trust relationship between the client device 102 and mediation server 112 may be leveraged to delegate management of multiple distribution servers 104. The use of mediation servers in conjunction with auxiliary content distribution is described in commonly assigned U.S. patent application Ser. No. 11/759,143, to James E. Marr et al., entitled “MEDIATION FOR AUXILIARY CONTENT IN AN INTERACTIVE ENVIRONMENT” which has been incorporated herein by reference.

In some embodiments, the system 100 may further include one or more reporting servers 108 coupled to the network 101. Client devices 102 may report user activity related to the auxiliary content. For example, in the case of auxiliary content in the form of advertising, the client devices 102 may be configured to report information to the reporting server 108 relating to whether an advertisement was displayed and/or made an impression on the user. Examples of such impression reporting are described, e.g., in commonly-assigned U.S. patent application Ser. No. 11/241,229, filed Sep. 30, 2005, the entire contents of which are incorporated herein by reference. In some embodiments, the mediation server 112 may also provide a URL for a reporting server 108 and a cryptographic key for communicating with the reporting server.

According to embodiments of the present invention, computer-implemented methods for obtaining and distributing auxiliary content for an interactive environment are provided. Examples of suitable simulated environments include, but are not limited to, video games and interactive virtual worlds. Examples of virtual worlds are described in commonly assigned U.S. patent application Ser. Nos. 11/682,281, 11/682,284, 11/682,287, 11/682,292, 11/682,298, and 11/682,299, the contents of all of which are incorporated herein by reference.

According to an embodiment of the present invention, the client device 102 may generate a pre-hint vector PV based on a position and movement of a point of view (POV) in the simulated environment. The client device 102 may send the pre-hint vector PV to a server 104. The server 104 receives the pre-hint vector PV from a client device 102 and determines a future field of view (FOV) using the information included in the pre-hint vector PV. The server then identifies one or more auxiliary content targets within the potential future FOV and sends auxiliary content information ACI to the client device. The auxiliary content information ACI relates to auxiliary content for the one or more auxiliary content targets within the potential future field of view (FOV). The client device 102 receives the auxiliary content information ACI. The client device may pre-fetch auxiliary content for one or more auxiliary content targets based on the auxiliary content information ACI.

FIGS. 1A-1B illustrate an example of a simulated environment containing auxiliary content within the context of an embodiment of the present invention. By way of example, a client device 102 may include a console 120. The simulated environment may be generated using simulation software 122 running on a processor that is part of the console 120. Camera management system 124 and vector generation instructions 126 may also run on the console 120. Execution of the simulation software 122 and operation of the camera management system 124 on the console 120 causes images to be displayed on a video display 128. The camera management system 124 may be implemented on the console 120 through suitably configured hardware and/or software. The simulated environment may include one or more auxiliary content targets 101A, 101B, 101C, and 101D. Examples of advertising targets are described, e.g., in U.S. Patent Published Patent Application Number 20070079331, which has been incorporated herein by reference in its entirety for all purposes. A scene 121 displayed to the user U may be controlled, at least in part, by a camera management system 124 operable with the simulated environment. As used herein a “scene” refers to a displayed portion of a simulated environment. The pre-hint vector generation instructions 126 may generate the pre-hint vector based on position and velocity information of a POV determined by the simulation software 122 and/or camera management system 124.

The camera management system 124 may determine a position within the simulated environment from which the simulated environment is viewed for the purpose of displaying the scene 121. The camera management system 124 may also determine an angle from which the scene is viewed. Furthermore, the camera management system 124 may also determine limits on the width, height and depth of a field-of-view of the portion of the scene. The scene 121 may be thought of as a display of a portion of the simulated environment from a particular point-of-view within the simulated environment. As shown in FIG. 1B, the scene 121 may be displayed from a point-of-view (camera POV) 125 on the video display 128. The scene 121 may encompass that portion of the simulated environment that lies within a frustum 127 with a virtual camera 129 located at a narrow end thereof. The point-of-view 125 is analogous to a position and orientation of a camera photographing a real scene and the frustum 127 is analogous to the field-of-view of the camera as it photographs the scene. Because of the aptness of the analogy, the particular point of view is referred to herein as a camera point-of-view (camera POV) and the frustum 127 is referred to herein as the camera field of view (FOV). The camera POV 125 generally includes a location (e.g., x, y, z) of the virtual camera 129 and an orientation (e.g., pitch, roll and yaw angle) of the virtual camera 129. Changing the location or orientation of the virtual camera 129 causes a shift in the scene 121 that is displayed on the video display 128. The camera orientation may include a viewing direction V. The viewing direction V may be defined as a unit vector oriented perpendicular to a center of a narrow face of the camera frustum 127 and pointing into the camera FOV. The viewing direction V may change with a change in the pitch and/or yaw of the virtual camera 129. The viewing direction V may define the “roll” axis of the virtual camera 129. It is noted that the field of view 127 may have a limited range from the camera POV 125 based on some lower limit of resolution of content displayed on the auxiliary content targets within the FOV 127.

There are a number of different possible configurations for the camera POV 125 and camera frustum 127. By way of example, and without limitation, the user' may control an avatar A through which the user U may interact with the virtual world. The camera POV 125 may be chosen to show the avatar A within the simulated environment from any suitable angle. Alternatively, the camera POV 125 may be chosen so that the video display 128 presents the scene from the avatar's point of view.

As shown schematically in FIG. 1B, the scene 121 shows that portion of the simulated environment that lies within the frustum 127. The scene 121 may change as the camera POV 125 changes in response to movement of the camera POV 125 along a camera path 131 during the user's interaction with the simulated environment. The camera management system 124 may automatically generate a view of the scene 121 within the simulated environment based on the camera path 131. The simulation software 122 may determine the camera path 131 partly in to a state of execution of instructions of the software 122 and partly in response to movement commands initiated by the user U. The user U may initiate such movement commands by way of an interface 130 coupled to the console 120. The displayed scene 121 may change as the camera POV 125 changes in response to movement of the camera POV 125 and camera frustum 127 along the camera path 131 during the user's interaction with the simulated environment. The camera path 131 may be represented by a set of data values that represent the location (x, y, z) and orientation (yaw, pitch, roll) of the camera POV 125 at a plurality of different time increments during the user's interaction with the simulated environment. A velocity vector v for the POV may be computed from the relative displacement of the POV 125 between from one frame to another. It is noted that the viewing direction θ and the velocity vector v may point in different directions. It is further noted that embodiments of the present invention may use position and velocity calculated for a POV other than the camera POV. For example, a position and velocity for the avatar A may be used as an alternative to the camera POV 125.

The pre-hint vector generation instructions 126 may generate a pre-hint in a number of different ways. By way of example, and without loss of generality, the pre-hint vector generation instructions 126 may generate a pre-hint vector PV containing the current POV 125, viewing angle θ and POV velocity v determine a future POV in a suitable data format. Specifically, the pre-hint vector PV may have the form:

PV=(x, y, z, vₓ, v_{y}, v_{z}, t), where x, y, and z represent the coordinates of the position of the camera POV 125 and vₓ, v_{y}, and v_{z} represent the coordinates of the POV velocity v at time t. The pre-hint vector PV may additionally include components θₓ, θ_{y}, θ_{z}, representing the angular components of the viewing angle θ and components ωₓ, ω_{y}, ω_{z}, representing the components of the rate of change of the viewing angle θ. The pre-hint vector may also optionally include components of the translational acceleration of the POV 125 and the angular acceleration of the viewing angle θ.

Based on the information in the pre-hint vector PV, the server 104 may compute a potential future field of view (FOV) 133. In particular, the server 104 may estimate a potential future POV 135 or range of such points of view from the POV coordinates x, y, z and the velocity vector v. The server 104 may further determine a potential future viewing angle θ′ or range of future viewing angles from the viewing angle θ and angular velocity information. The server 104 may then compute the potential future field of view 133, e.g., by displacing the POV 125 of the current FOV 127 to each potential future POV 135 and superposing the resulting frustum on a stored map of the simulated environment. The server may then retrieve information relating to auxiliary content targets within the potential future field of view 133. In the example depicted in FIG. 1B, the server 104 would return auxiliary content information ACI relating to targets 101B and 101C but not targets 101A and 101D.

In the foregoing example the potential future FOV 133 was determined from a single pre-hint vector PV. However, embodiments of the present invention are not limited to such an implementation. Instead, the server 104 may compute a potential future FOV 133 may be computed based on multiple pre-hint vectors obtained at different instances of time. The server 104 may receive multiple pre-hint vectors from a given client device 102 over a period of time. The server 104 may then compute the future FOV and send auxiliary content when it deems appropriate. As an example of a situation where multiple pre-hint vectors may be useful, consider a situation where a player (or the player's avatar) is running around in a circle, e.g., if the player is racing another player). If the server 104 only uses a single pre-hint vector containing the instantaneous velocity, may be difficult to figure out that the user has been running in a circle. However, with multiple pre-hint vectors over a period of time, the server 104 could employ many mathematical techniques to build a more accurate Potential Future FOV. By way of example, the server 104 may determine the future FOV 133 using a polynomial fit algorithm applied to a suitable number of pre-hint vectors.

Furthermore, in some embodiments, the server 104 may prioritize the order of the auxiliary content so that the client device 102 downloads auxiliary content that is closer to the camera POV first. For example, in a video game situation, the server 104 may provide the client a list of all of the auxiliary content for an entire level, e.g., the current level or the next level. The server 104 may also use the calculated Potential Future FOV 133 to sort that list so that the content closer to the future POV 135 appears first in the list and the client device 102 downloads that content first.

In addition, the pre-hint vector may include information other than camera position, orientation, velocity, and the like. For example, the pre-hint vector may include information relating to a previously-saved state of the simulated environment. For example, in the context of a video game, a user often saves the state of the game before exiting the game at the end of a session. Video games often have different “levels”, which refer to different portions of the game related to different challenges or tasks presented to the user. Often the level that the user was on is saved as part of the state of the game. Such information may be regarded as being related to a “position” of the POV (or the user's avatar) within the simulated environment of the game. The client device 102, through execution of a program, such as a game program, may inspect the state of the simulated environment and determine such information as part of a saving the state. This information may be included in the pre-hint vector sent to the server 104. For example, in the case of a video game, suppose that a player's most recent save game is on level 4. This information may be sent to the server 104 in a pre-hint vector. The server 104 may then send the client device 102 the auxiliary content information for level 4.

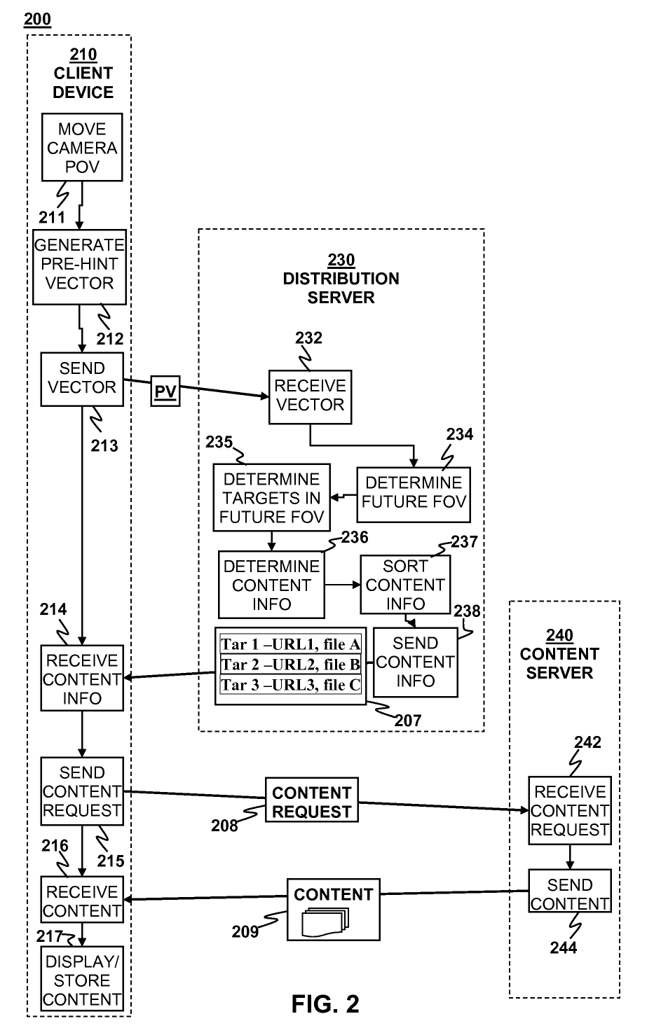

As shown in FIG. 2, the system 100 may be configured to distribute auxiliary content according to an inventive method 200. Various aspects of the method 200 may be implemented by execution of computer executable instructions running on the client device 102 and/or distribution servers 104. Specifically, a client device 102 may be configured, e.g., by suitable programming, to implement certain client device instructions 210. In addition, a distribution server 104 may be configured to implement certain mediation server instructions 230. Furthermore, a content server 106 may be configured to implement certain content server instructions 240.

Specifically, as indicated at 211 the client device 102 may move a point of view (POV) in response to input from a user. Based on the position and movement of the POV, the client device may generate one or more pre-hint vectors PV as indicated at 212 to send to a distribution server 104, as indicated at 213. The distribution server 104 receives the pre-hint vector(s) from the client device 102 as indicated at 232 and uses the pre-hint vector(s) to determine a future field of view as indicated at 234. The future FOV may be determined from the pre-hint vector as described above with respect to FIG. 1B or through the use of multiple pre-hint vectors obtained at different times. The distribution server 104 then identifies targets for auxiliary content that lie within the future FOV, as indicated at 235. This may involve a lookup in a table listing content target locations for the entire simulated environment or a portion thereof The server 104 may compare locations that are within the future field of view to locations for auxiliary targets to determine if there are any matches. If any matches are identified, the server may then determine the relevant content information for each identified target, as indicated at 236. By way of example, the distribution server 104 may then determine which of one or more content servers 106 contains the auxiliary content for identified targets within the future FOV. In some cases, auxiliary content for different spaces in the simulated environment may be stored on different content servers 106. In addition, the content information may optionally be sorted, as indicated at 237. After determining which content servers 106 contain the content for the identified targets, the distribution server 104 may send content information 207 to the client device 102, as indicated at 238. The content information 207 may contain information indicating which auxiliary content asset is to be displayed in a given auxiliary content space within the simulated environment generated by the client device 102. The content information 207 may include a list of auxiliary content items that are sorted in order of proximity of the target spaces to the future camera POV determined from the pre-hint vector.

By way of example, the content information 207 may provide information for one or more auxiliary content spaces. Each auxiliary content space information may contain a space identifier, a list of one or more assets associated with each space identifier and one or more addresses, e.g., one or more URLs, for one or more selected content servers 106 from which the assets may be downloaded. It is noted that two or more different content servers 106 may be associated with each auxiliary content space. Specifically, this information may be in the form of a list or table associated with each auxiliary content space. The list may identify one or more auxiliary content spaces using space identifiers, one or more URLs and a list of file names for one or more corresponding auxiliary content assets that can be downloaded from each URL. For example, content files A, B, and C may be downloaded at URL1, URL2 and URL3 respectively, for auxiliary content spaces 1, 2 and 3.

After receiving the content information 207, as indicated at 214, the client device 102 may send one or more content requests 208 to the one or more selected content servers 106 as indicated at 215. The content request for each selected content server 106 may include a list of auxiliary content files to be downloaded from the content server 106. Such a list may be derived from the content information 207 obtained from the distribution server 104. After receiving the content request 208, as indicated at 242, the content server may send auxiliary content assets 209 (e.g., text, image, video, audio, animation or other files) corresponding to the requested content, as indicated at 244. The client device 102 may then receive the assets 209 at 216 and (optionally) display the auxiliary content using the assets 209 and/or store the assets as indicated at 217. By way of example, the simulated environment in the form of a video game may include one or more advertising spaces, e.g., billboards, etc. Such spaces may be rendered as images depicting a scene, landscape or background within the game that is displayed visually. Advertising content may be displayed in these spaces may be displayed using the content assets 209 during the course of the normal operation of the game. Alternatively, advertising content assets 209 may be stored in a computer memory or hard drive in locations associated with the advertising spaces and displayed at a later time.

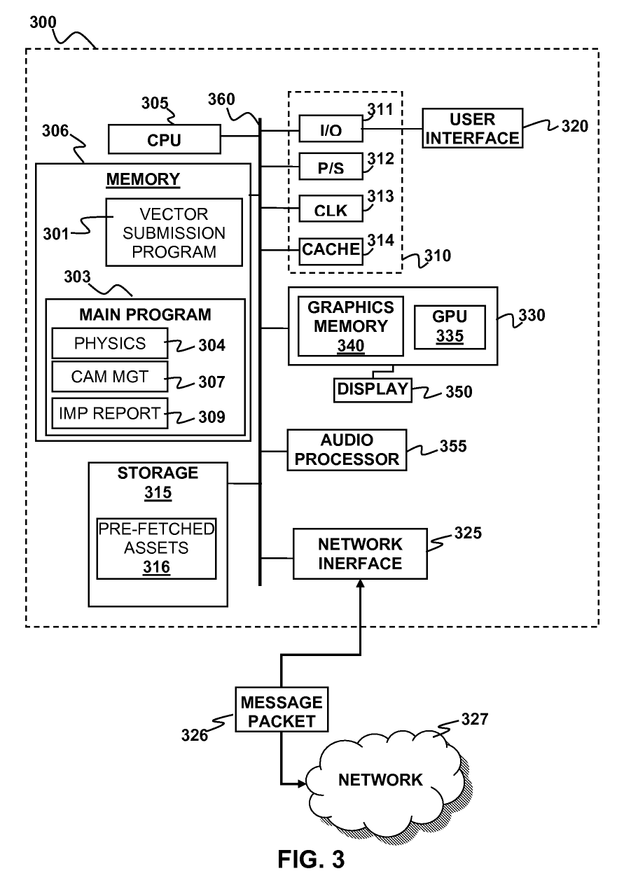

By way of example, the client device 102 may be configured as shown in FIG. 3, which depicts a block diagram illustrating the components of a client device 300 according to an embodiment of the present invention. By way of example, and without loss of generality, the client device 300 may be implemented as a computer system, such as a personal computer, video game console, personal digital assistant, or other digital device, suitable for practicing an embodiment of the invention. The client device 300 may include a central processing unit (CPU) 305 configured to run software applications and optionally an operating system. The CPU 305 may include one or more processing cores. By way of example and without limitation, the CPU 305 may be a parallel processor module, such as a Cell Processor. An example of a Cell Processor architecture is described in detail, e.g., in Cell Broadband Engine Architecture, copyright International Business Machines Corporation, Sony Computer Entertainment Incorporated, Toshiba Corporation Aug. 8, 2005 a copy of which may be downloaded at http://cell.scei.cojp/, the entire contents of which are incorporated herein by reference.

A memory 306 is coupled to the CPU 305. The memory 306 may store applications and data for use by the CPU 305. The memory 306 may be in the form of an integrated circuit, e.g., RAM, DRAM, ROM, and the like). A computer program 301 may be stored in the memory 306 in the form of instructions that can be executed on the processor 305. The instructions of the program 301 may be configured to implement, amongst other things, certain steps of a method for obtaining auxiliary content, e.g., as described above with respect to FIGS. 1A-1B and the client-side instructions 210 in FIG. 2. By way of example, the program 301 may include instructions to generate a pre-hint vector based on a position and movement of a point of view (POV) in the simulated environment, send the pre-hint vector PV to a server 104, receive auxiliary content information from the server in response and pre-fetch auxiliary content assets 316 for one or more auxiliary content targets based on the auxiliary content information.

The program 301 may operate in conjunction with one or more instructions configured to implement an interactive environment. By way of example, such instructions may be a subroutine or callable function of a main program 303, such as a video game program. Alternatively, the main program 303 may be a program for interfacing with a virtual world. The main program 303 may be configured to display a scene of a portion of the simulated environment from the camera POV on a video display and change the scene as the camera POV changes in response to movement of the camera POV along a camera path during the user's interaction with the simulated environment. The main program may include instructions for physics simulation 304, camera management 307 and reporting advertising impressions 309. The main program 303 may call the impression enhancement program 301, physics simulation instructions 304, camera management instructions 307 and advertising impression reporting instructions 309, e.g., as a functions or subroutines.

The client device 300 may also include well-known support functions 310, such as input/output (I/O) elements 311, power supplies (P/S) 312, a clock (CLK) 313 and cache 314. The client device 300 may further include a storage device 315 that provides non-volatile storage for applications and data. The storage device 315 may be used for temporary or long-term storage of auxiliary content assets 316 downloaded from a content server 120. By way of example, the storage device 315 may be a fixed disk drive, removable disk drive, flash memory device, tape drive, CD-ROM, DVD-ROM, Blu-ray, HD-DVD, UMD, or other optical storage devices. Pre-fetched assets 316 may be temporarily stored in the storage device 315 for quick loading into the memory 306.

One or more user input devices 320 may be used to communicate user inputs from one or more users to the computer client device 300. By way of example, one or more of the user input devices 320 may be coupled to the client device 300 via the I/O elements 311. Examples of suitable input device 320 include keyboards, mice, joysticks, touch pads, touch screens, light pens, still or video cameras, and/or microphones. The client device 300 may include a network interface 325 to facilitate communication via an electronic communications network 327. The network interface 325 may be configured to implement wired or wireless communication over local area networks and wide area networks such as the Internet. The client device 300 may send and receive data and/or requests for files via one or more message packets 326 over the network 327.

The client device 300 may further comprise a graphics subsystem 330, which may include a graphics processing unit (GPU) 335 and graphics memory 340. The graphics memory 340 may include a display memory (e.g., a frame buffer) used for storing pixel data for each pixel of an output image. The graphics memory 340 may be integrated in the same device as the GPU 335, connected as a separate device with GPU 335, and/or implemented within the memory 306. Pixel data may be provided to the graphics memory 340 directly from the CPU 305. Alternatively, the CPU 305 may provide the GPU 335 with data and/or instructions defining the desired output images, from which the GPU 335 may generate the pixel data of one or more output images. The data and/or instructions defining the desired output images may be stored in memory 310 and/or graphics memory 340. In an embodiment, the GPU 335 may be configured (e.g., by suitable programming or hardware configuration) with 3D rendering capabilities for generating pixel data for output images from instructions and data defining the geometry, lighting, shading, texturing, motion, and/or camera parameters for a scene. The GPU 335 may further include one or more programmable execution units capable of executing shader programs.

The graphics subsystem 330 may periodically output pixel data for an image from the graphics memory 340 to be displayed on a video display device 350. The video display device 350 may be any device capable of displaying visual information in response to a signal from the client device 300, including CRT, LCD, plasma, and OLED displays. The computer client device 300 may provide the display device 350 with an analog or digital signal. By way of example, the display 350 may include a cathode ray tube (CRT) or flat panel screen that displays text, numerals, graphical symbols or images. In addition, the display 350 may include one or more audio speakers that produce audible or otherwise detectable sounds. To facilitate generation of such sounds, the client device 300 may further include an audio processor 355 adapted to generate analog or digital audio output from instructions and/or data provided by the CPU 305, memory 306, and/or storage 315.

The components of the client device 300, including the CPU 305, memory 306, support functions 310, data storage 315, user input devices 320, network interface 325, and audio processor 355 may be operably connected to each other via one or more data buses 360. These components may be implemented in hardware, software or firmware or some combination of two or more of these.

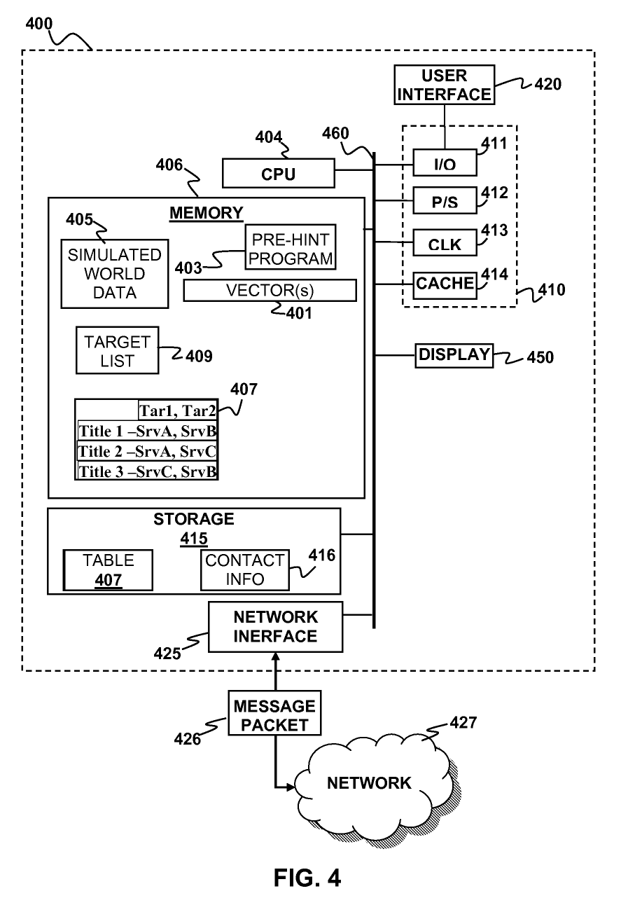

By way of example, and without loss of generality, the distribution servers 104 in the system 100 may be configured as shown in FIG. 4. According to an embodiment of the present invention, a distribution server 400 may be implemented as a computer system or other digital device. The distribution server 400 may include a central processing unit (CPU) 404 configured to run software applications and optionally an operating system. The CPU 404 may include one or more processing cores. By way of example and without limitation, the CPU 404 may be a parallel processor module, such as a Cell Processor.

A memory 406 is coupled to the CPU 404. The memory 406 may store applications and data for use by the CPU 404. The memory 406 may be in the form of an integrated circuit, e.g., RAM, DRAM, ROM, and the like). A computer program 403 may be stored in the memory 406 in the form of instructions that can be executed on the processor 404. A current update value 401 may be stored in the memory 406. The instructions of the program 403 may be configured to implement, amongst other things, certain steps of a method for pre-hint streaming of auxiliary content, e.g., as described above with respect to the distribution-side operations 230 in FIG. 2. Specifically, the distribution server 400 may be configured, e.g., through appropriate programming of the program 403, to receive one or more pre-hint vectors 401 from a client device, determine a future field of view (FOV) using the information included in the pre-hint vector(s) 401, identify one or more auxiliary content targets within the potential future FOV and sends auxiliary content information for those targets to the client device.

The memory 406 may contain simulated world data 405. The simulated world data 405 may include information relating to the geography and status of objects within the simulated environment. The pre-hint program 403 may also select one or more content servers from among a plurality of content servers based on a list 409 of auxiliary content targets generated by the program 403 using the simulated world data 405 and the pre-hint vector 401. For example, the memory 406 may contain a cross-reference table 407 with a listing of content servers organized by game title and advertising target within the corresponding game. The program 403 may perform a lookup in the table for the content server that corresponds to a title and auxiliary content targets in the list 409.

The distribution server 400 may also include well-known support functions 410, such as input/output (I/O) elements 411, power supplies (P/S) 412, a clock (CLK) 413 and cache 414. The mediation server 400 may further include a storage device 415 that provides non-volatile storage for applications and data. The storage device 415 may be used for temporary or long-term storage of contact information 416 such as distribution server addresses and cryptographic keys. By way of example, the storage device 415 may be a fixed disk drive, removable disk drive, flash memory device, tape drive, CD-ROM, DVD-ROM, Blu-ray, HD-DVD, UMD, or other optical storage devices.

One or more user input devices 420 may be used to communicate user inputs from one or more users to the mediation server 400. By way of example, one or more of the user input devices 420 may be coupled to the mediation server 400 via the I/O elements 411. Examples of suitable input device 420 include keyboards, mice, joysticks, touch pads, touch screens, light pens, still or video cameras, and/or microphones. The mediation server 400 may include a network interface 425 to facilitate communication via an electronic communications network 427. The network interface 425 may be configured to implement wired or wireless communication over local area networks and wide area networks such as the Internet. The mediation server 400 may send and receive data and/or requests for files via one or more message packets 426 over the network 427.

The components of the distribution server 400, including the CPU 405, memory 406, support functions 410, data storage 415, user input devices 420, and network interface 425, may be operably connected to each other via one or more data buses 460. These components may be implemented in hardware, software or firmware or some combination of two or more of these.

Embodiments of the present invention facilitate management of consistency of content assets cached on a client device without placing an undue burden for such management on the client device itself. By off-loading the responsibility for determining which assets to pre-fetch, embodiments of the present invention can facilitate rapid acquisition of auxiliary content assets without placing an additional computational strain on the device that uses those assets.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. In a client device configured to interact with an interactive environment containing one or more auxiliary content targets, a computer implemented method for obtaining auxiliary content, comprising:
a) displaying a scene of a portion of the simulated environment based on a point of view (POV) on a video display;
b) generating a pre-hint vector based on a position of the POV in the simulated environment;
c) sending the pre-hint vector to a server;
d) receiving auxiliary content information from the server, wherein the auxiliary content information relates to auxiliary content for one or more auxiliary content targets within a potential future field of view determined from the pre-hint vector; and
e) pre-fetching the auxiliary content for the one or more auxiliary content targets.

2. The method of claim 1 wherein the pre-hint vector includes information relating to position coordinates for the POV within the simulated environment.

3. The method of claim 2 wherein the pre-hint vector includes information relating to a viewing angle of a camera POV.

4. The method of claim 1 wherein the pre-hint vector includes information relating to movement of the point of view (POV) in the simulated environment.

5. The method of claim 4 wherein the pre-hint vector includes information relating to a velocity of the POV.

6. The method of claim 1 wherein the pre-hint vector includes information relating to a previously saved state of the simulated environment for the client device.

7. The method of claim 4 wherein the pre-hint vector includes information relating to a rate of change of a viewing angle of the camera POV.

8. The method of claim 1 wherein the auxiliary content information includes an auxiliary content asset for a target within the potential future field of view may be downloaded.

9. The method of claim 1 wherein the auxiliary content information includes an address of a content server from which auxiliary content for a target within the interactive environment within the potential future field of view may be downloaded.

10. The method of claim 9 wherein the auxiliary content information includes a list of one or more auxiliary content assets for the target.

11. The method of claim 10, wherein e) comprises contacting the content server with a request for the one or more auxiliary content assets.

12. The method of claim 11, further comprising receiving the one or more auxiliary content assets from the content server.

13. The method of claim 12, further comprising using the one or more auxiliary content assets to display the auxiliary content in the one or more auxiliary content spaces in the interactive environment.

14. The method of claim 1 wherein the auxiliary content comprises advertising content.

15. The method of claim 1 wherein the simulated environment is an environment of a video game.

16. The method of claim 1 wherein the auxiliary content information includes a list of auxiliary content items sorted in order of proximity to a future point of view determined from the pre-hint vector.

17. The method of claim 16 wherein e) includes pre-fetching the auxiliary content for the one or more auxiliary content targets in order of proximity to the future point of view.

18. A client device configured to interact with an interactive environment, comprising:
a processor;
a memory coupled to the processor;
one or more instructions embodied in memory for execution by the processor, the instructions being configured to implement a method for obtaining auxiliary content for an interactive environment, the method comprising:
a) displaying a scene of a portion of the simulated environment from a point of view (POV) on a video display;
b) generating a pre-hint vector based on a position of the POV in the simulated environment;
c) sending the pre-hint vector to a server;
d) receiving auxiliary content information from the server, wherein the auxiliary content information relates to auxiliary content for one or more auxiliary content targets within a potential future field of view determined from the pre-hint vector.

19. The client device of claim 18, further comprising one or more instructions embodied in memory configured to implement the interactive environment.

20. The client device of claim 18 wherein the interactive environment is a video game.

21. In a server, a computer implemented method for managing distribution of auxiliary content, comprising:
a) receiving a pre-hint vector from a client device, wherein the pre-hint vector includes information based on a position of a point of view (POV) in the simulated environment;
b) determining a future field of view using the information included in the pre-hint vector;
c) identifying one or more auxiliary content targets within the potential future field of view; and
d) sending auxiliary content information to the client device, wherein the auxiliary content information relates to auxiliary content for the one or more auxiliary content targets within the potential future field of view (FOV).

22. The method of claim 21 wherein the pre-hint vector includes information relating to position coordinates for the POV within the simulated environment.

23. The method of claim 21 wherein the pre-hint vector includes information relating to a viewing angle of a camera POV.

24. The method of claim 21 wherein the pre-hint vector includes information relating to movement of the point of view (POV) in the simulated environment.

25. The method of claim 24 wherein the pre-hint vector includes information relating to a velocity of the POV.

26. The method of claim 24 wherein the pre-hint vector includes information relating to a rate of change of a viewing angle of the POV.

27. The method of claim 21 wherein the pre-hint vector includes information relating to a previously saved state of the simulated environment for the client device.

28. The method of claim 21, wherein b) includes determining a future POV from position coordinates of the POV and a velocity vector for the POV and determining the potential FOV from the future POV.

29. The method of claim 21 wherein the auxiliary content information includes an address for the content server from which auxiliary content for a target within the interactive environment within the potential future field of view may be downloaded.

30. The method of claim 21 wherein a) includes receiving a plurality of pre-hint vectors from the client device.

31. The method of claim 30, wherein b) includes determining the future field of view using the plurality of pre-hint vectors.

32. The method of claim 21 wherein c) includes sorting a list of auxiliary content items according to the proximity of corresponding locations in the simulated environment with respect to a future point of view determined from the pre-hint vector.

33. A server, comprising:
a processor;
a memory; and
one or more instructions embodied in memory for execution by the processor, the instructions being configured to implement a method for managing distribution of auxiliary content, the method comprising:
a) receiving a pre-hint vector from a client device, wherein the pre-hint vector includes information based on a position and movement of a point of view (POV) in the simulated environment;
b) determining a future field of view using the information included in the pre-hint vector;
c) identifying one or more auxiliary content targets within the potential future field of view; and
d) sending auxiliary content information to the client device, wherein the auxiliary content information relates to auxiliary content for the one or more auxiliary content targets within the potential future field of view (FOV).

34. The server of claim 33, wherein b) includes determining a future POV from the position coordinates and the velocity vector and determining the potential future FOV from the future POV.

35. The server of claim 33 wherein the auxiliary content information includes an address for the content server from which auxiliary content for a target within the interactive environment within the potential future field of view may be downloaded.
